(19) United States
(12) Patent Application Publication
(10) Pub. No.: US 2026/0175127 A1
(43) Pub. Date: Jun. 25, 2026

(54) INFORMATION RECOMMENDATION METHOD AND APPARATUS, AND ELECTRONIC DEVICE

(71) Applicant: NETEASE (HANGZHOU) NETWORK CO., LTD., Hangzhou, Zhejiang (CN)

(72) Inventor: Zongmin CHEN, Shanghai (CN)

(73) Assignee: NETEASE (HANGZHOU) NETWORK CO., LTD., Hangzhou, Zhejiang (CN)

(21) Appl. No.: 18/856,643

(22) PCT Filed: Mar. 2, 2023
(86) PCT No.: PCT/CN2023/079233

§ 371 Date: Oct. 14, 2024

(30) Foreign Application Priority Data
Apr. 18, 2022 (CN) 202210405737.6

(51) Int. Cl. A63F 13/5375; A63F 13/355; A63F 13/533; G06F 3/0484

(52) U.S. Cl. CPC A63F 13/5375; A63F 13/533; A63F 13/355; G06F 3/0484

(57) ABSTRACT

An information recommendation method includes: in response to receiving an information recommendation instruction, acquiring first video information from the information recommendation instruction, the first video information including operation instruction information for realizing a target function; determining a play position of the first video information in a graphical user interface, the play position includes at least one of a video play window or a target function control related to the target function in the graphical user interface; and playing the first video information at the play position.

### CROSS REFERENCE TO RELATED APPLICATION(S)

The present application is a U.S. National Stage of International Application No. PCT/CN2023/079233, filed on Mar. 2, 2023, which claims priority to Chinese patent application number 202210405737.6, filed on Apr. 18, 2022 and entitled “Information Recommendation Method and Apparatus and Electronic Device”, the entire contents of which are incorporated herein by reference in their entirety for all purposes.

### TECHNICAL FIELD

Embodiments of the present disclosure relate to the game technical field, and in particular, to an information recommendation method and apparatus, and an electronic device.

### BACKGROUND

As games are constantly improved and updated, functions and gameplay in games are becoming increasingly complicated, and it is difficult for most players to fully experience all functions and gameplay in games. In related art, an access interface for a new function may be added in an interface, and the access interface may be a button, a list, a scene button, a scene area entry, etc. After a player triggers the access interface, the player may experience the new function, or view a new function introduction page which usually introduces the new function in a form of text and pictures. This method has limited effects of recommendation of the new function, and it is difficult for the game to provide players with continuous freshness, thereby resulting in a high player churn rate.

### SUMMARY

In an aspect, the present disclosure provides an information recommendation method. The method includes: in response to receiving an information recommendation instruction, acquiring first video information from the information recommendation instruction, wherein the first video information includes operation instruction information for realizing a target function; determining a play position of the first video information in a graphical user interface; wherein the play position includes at least one of a video play window or a target function control related to the target function in the graphical user interface; and playing the first video information at the play position.

In a further aspect, the present disclosure provides an electronic device including a processor and a memory. The memory stores machine-executable instructions that are executable by the processor, and when the processor executes the machine-executable instructions, the above-mentioned information recommendation method is implemented.

In a further aspect, the present disclosure provides a machine-readable storage medium having machine-executable instructions stored thereon. When the machine-executable instructions are called and executed by a processor, the machine-executable instructions cause the processor to implement the above-mentioned information recommendation method.

Other features and advantages of the present disclosure will be described in the following description, and partly become apparent from the specification, or be understood by practicing the present disclosure. The purpose and other advantages of the present disclosure are realized and obtained by the structures particularly pointed out in the specification, claims and drawings.

In order to make the above-mentioned objectives, features and advantages of the present disclosure more obvious and easy to understand, example embodiments are specifically set forth below and described in detail with reference to the accompanying drawings.

### BRIEF DESCRIPTION OF THE DRAWINGS

The accompanying drawings herein are incorporated into the specification and constitute a part of the specification, illustrate embodiments consistent with the present disclosure, and are used to explain the principles of the present disclosure together with the specification. Obviously, the accompanying drawings described below are only some embodiments of the present disclosure, and for one of ordinary skill in this art, other drawings can be obtained based on these accompanying drawings without creative work.

FIG. 1 is a flowchart of an information recommendation method according to an embodiment of the present disclosure;

FIG. 2 is a schematic diagram of a graphical user interface according to an embodiment of the present disclosure;

FIG. 3 is a schematic diagram of playing first video information in a video play window according to an embodiment of the present disclosure;

FIG. 4 is a schematic diagram of playing first video information on a function control according to an embodiment of the present disclosure;

FIG. 5 is a schematic diagram of controlling a screen recording operation according to an embodiment of the present disclosure;

FIG. 6 is a schematic diagram of another method for controlling a screen recording operation according to an embodiment of the present disclosure;

FIG. 7 is a schematic diagram of the structure of an information recommendation apparatus according to an embodiment of the present disclosure; and

FIG. 8 is a schematic diagram of an electronic device according to an embodiment of the present disclosure.

### DETAILED DESCRIPTION

Example embodiments will now be described more fully with reference to the accompanying drawings. However, example embodiments can be implemented in a variety of forms and should not be construed as being limited to the examples set forth herein. Rather, these embodiments are provided so that the present disclosure will be more comprehensive and complete and will fully convey the concept of the example embodiments to those skilled in the art.

In addition, the described features, structures or characteristics may be combined in one or more embodiments in any suitable manner. In the following description, many specific details are provided to provide a full understanding of the embodiments of the present disclosure. However, those skilled in the art will appreciate that the technical solutions of the present disclosure may be practiced without one or more of the specific details, or other methods, components, devices, steps, etc. may be adopted. In other cases, known methods, devices, implementations or operations are not shown or described in detail to avoid blurring the various aspects of the present disclosure.

The block diagrams shown in the accompanying drawings are merely functional entities and do not necessarily correspond to physically independent entities. That is, these functional entities may be implemented in a software form, or in one or more hardware modules or integrated circuits, or in different networks and/or processor devices and/or microcontroller devices.

The flowcharts shown in the accompanying drawings are only illustrative and do not necessarily include all the contents and operations/steps, and the operations/steps do not have to be performed in the order described. For example, some operations/steps may be decomposed, and some operations/steps may be combined or partially combined, and thus the actual execution order may change according to actual situations.

Functions and gameplay in a game are rich and varied, and it is difficult for most players to fully experience all the functions and gameplay of a game. The main reasons are as follows. If players experience all the functions and gameplay of the game linearly, they need to invest a lot of time cost. However, the current players' game play methods tend to be fragmented, non-linear and low-concentration. It is difficult for players who use this game play method to invest a lot of time, and thus the players usually only experience a part of the functions and gameplay of the game. In addition, when players form their own gameplay preferences and interaction habits, they will gradually lose the motivation to explore new functions. When the players' freshness to the game drops to a certain level, the game will lose these players. In embodiments of the present disclosure, players may also be called users.

In related art, games usually have a recommendation function for recommending new functions and gameplay. By setting a function control or a function control list in a graphical user interface, by or setting a scene control or a new function entry or the like in a game scene, players are guided to enter an operation interface of the new function, or introduction information of the new function is presented to the players.

In the above method, the introduction information of the new function is usually presented in a form of text or static picture(s), with less information and a single function mapping relationship. It is difficult for static forms such as text and pictures to present complex operations and there is a high cognitive cost.

Moreover, with regard to the method of setting a function control in a graphical user interface, different functions correspond to different buttons, the operation efficiency of a single control is relatively low, and the utilization rate of the screen space is also low. When the game system is complex, a large number of entries are required. There is an upper limit on the number of entry layouts, and too many entry controls occupy the presentation space for information control(s) or effect scene(s). Also, the effect of presentation of streaming media content is poor, and manual maintenance is required.

With regard to the method of setting a function control list in a graphical user interface, this method mainly puts controls into a list, and functions may be indirectly entered through an interactive method of a control entry. The list selection in this method is still achieved through button(s), the efficiency of single control operation is relatively low, and the utilization rate of screen operation space is also low. This method is also limited by the number of controls. When the system is complicated, there may be large number of controls or large number of levels of controls in the list are large, and there is an upper limit on the number of list layouts. The effect of presentation of streaming media content is poor, and manual maintenance is required.

With regard to the method of setting a scene control in a game scene, this method is actually a derivative of an ordinary control. Different functions correspond to different controls and scenes, and this enables a strong sense of immersion but has low operating efficiency. There is a physical distance between different scene locations, and the operation of switching functions requires running a map, which interrupts players' thinking. It is difficult for text, pictures and a scene model to intuitively present complex operations, and players still need to perform exploration. The controls in the scene are displayed according to players' positions, and the screen space utilization rate of a single control is low. Although streaming media content may be embedded in the scene, adding streaming media to the model impose high requirements for traffic and performance.

With regard to the method of setting a new function entry in a game scene, this method is similar to the above-mentioned scene control, and the difference is that different functions need to correspond to different areas, and the operation efficiency is low. There is a physical distance between locations of different scene areas, and the operation of switching functions requires running a map, which interrupts players' thinking. It is difficult for text, pictures and a scene model to intuitively present complex operations, and players still need to perform exploration. This method has a low tolerance rate of range interaction, and it is needed to increase the spatial area within the scene to avoid accidental touches. There is also an upper limit to the scene areas, and thus the number of entries is limited to a certain extent. Although streaming media content may be embedded in the scene, adding streaming media to the model impose high requirements for traffic and performance.

In view of the above, embodiments of the present disclosure provide an information recommendation method and apparatus and an electronic device. This technology may be applied to a recommendation scenario of new function(s) or new gameplay of various types of games.

In an embodiment of the present disclosure, the information recommendation method may be run on a local touch terminal device or a server. When the information recommendation method is run on a server, the method may be implemented and carried out based on a cloud interaction system. The cloud interaction system includes a server and a client device.

In an optional implementation, various cloud applications may be run under the cloud interaction system, such as cloud games. Taking a cloud game as an example, a cloud game refers to a game mode based on cloud computing. In the running mode of the cloud game, a body for running a game program and a body for presenting game graphics are separated. The storage and running of the information recommendation method are completed on the cloud game server. The role of the client device is used for receiving and sending data and presenting the game graphics. For example, the client device may be a display device with a data transmission function close to the user side, such as a mobile terminal, a TV, a computer, a handheld computer, etc.; but it is the cloud game server in the cloud that is used for information processing. When playing the game, a player operates the client device to send an operation instruction to the cloud game server. The cloud game server runs the game according to the operation instruction, encodes and compresses data such as game graphics, and returns the data to the client device through the network. Finally, the client device performs decoding and outputs the game graphics.

In an optional embodiment, taking a game as an example, a local touch terminal device stores a game program and is used to present game graphics. The local touch terminal device is used to interact with a player through a graphical user interface, that is, the game program is downloaded and installed and run by an electronic device in a conventional manner. The local touch terminal device may provide a graphical user interface to the player in a variety of ways. For example, the graphical user interface may be rendered and displayed on a display screen of the terminal, or the graphical user interface may be provided to the player through a holographic projection. For example, the local touch terminal device may include a display screen and a processor. The display screen is configured to present a graphical user interface, and the graphical user interface includes game graphics. The processor is configured to run the game, generate the graphical user interface, and control the graphical user interface to be displayed on the display screen.

In a possible implementation, an embodiment of the present disclosure provides an information recommendation method in which a graphical user interface is provided through a terminal device. The terminal device may be the local touch terminal device mentioned above, or may be the client device in the cloud interaction system mentioned above. A graphical user interface is provided through the terminal device, and the graphical user interface may display interface contents, such as game scene graphics, a communication interaction window, etc., according to the type of a started application program. In the embodiment, the graphical user interface includes game scene graphic(s) and function control(s). The game scene graphics are usually scene graphics of a part of the game scene captured by a virtual camera in the game scene. Function control(s) usually includes (include) various types of controls such as an attack control, a skill release control, a displacement remote sensing control, a backpack control, etc. Function control(s) is (are) usually displayed on the game scene graphics, and may shield the display of part of the game scene graphics.

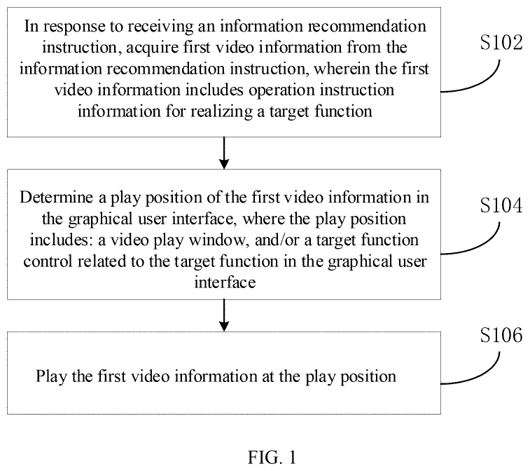

To facilitate understanding of the embodiment, an information recommendation method disclosed in the embodiment of the present disclosure is first introduced in detail. As shown in FIG. 1, the information recommendation method provides a graphical user interface through a terminal device. The terminal device may be the local terminal device described above or the client device described above. The method includes the following steps:

In step S102, in response to receiving an information recommendation instruction, first video information is acquired from the information recommendation instruction. The first video information includes operation instruction information for realizing a target function.

The information recommendation instruction is usually generated by the game server, and the first video information is usually uploaded by a user through the terminal device, or the first video information may be produced and uploaded by a background staff. The first video information usually also carries information related to the first video information, such as the target function realized by the first video information, or a type which the first video information belongs to, and may also include account attribute information of a user who uploaded the first video information, and a recommendation range set by the user. The game server generates the above-mentioned information recommendation instruction based on the first video information. The information recommendation instruction may be randomly sent to a terminal device of each user, or the information recommendation instruction may be sent to terminal devices of users within the recommendation range based on the recommendation range set by the user of the first video information. In other ways, the information recommendation instruction may also be sent to users whose commonly used functions do not include the target function corresponding to the first video information according to the commonly used functions of users.

The first video information usually includes operation information on how to realize the target function. In a specific implementation, the first video information is usually video information obtained by recording a screen when the user performs the operation of the target function. The first video information may include an operation procedure of performing all or part of operations of the target function. If the recorded video information is long, the video information may also be compressed to obtain a short video with a smaller data volume, which is the first video information corresponding to the target function.

In step S104, a play position of the first video information in the graphical user interface is determined. The play position includes: a video play window, and/or a target function control related to the target function in the graphical user interface.

In this embodiment, the play position of the first video information includes two types. One is a video play window, which may be pre-generated and displayed in the graphical user interface. The other type of play position includes a target function control related to the target function in the graphical user interface. For example, if the target function is to craft equipment A, the play position of the first video information may be a control in the graphical user interface for crafting the equipment A.

In an actual implementation, the play position may be determined randomly, or the information recommendation instruction may carry indication information indicating the play position of the first video information, and the play position of the first video information may be determined based on the indication information. Alternatively, the play position may be determined based on setting information of the current terminal device. For example, in the current terminal device, the user setting does not allow to display the video play window. At this time, the play position may only be the target function control. For another example, in the graphical user interface, the target function control related to the target function is not displayed. At this time, the play position is the video play window.

In a method, if the play position is the target function control related to the target function in the graphical user interface, it is needed to determine on which function control the first video information is played; based on this, function type information of the target function is acquired from the information recommendation instruction; and the target function control matching the function type information is determined from the graphical user interface. The function type information here may specifically include the function type of the target function, a subsystem to which the target function belongs, etc. For example, if the target function is to farm equipment, the subsystem to which the target function belongs is an equipment subsystem, and the target function control matching the target function may be an equipment farming control or an interface control of the equipment subsystem.

In step S106, the first video information is played at the play position.

By playing the first video information at the play position, the target function of the game is recommended to the user. The first video information may also have certain interactive functions, such as volume adjustment, switching, or scaling, etc. of the first video information, so as to meet the viewing needs of the user. If the user is interested in the target function recommended by the first video information, the user may enter the operation interface of the target function through the target function control or the video play window, so that the user can experience the target function.

In the above-mentioned information recommendation method, in response to receiving the information recommendation instruction, the first video information is acquired from the information recommendation instruction. The first video information includes operation instruction information for realizing the target function. The play position of the first video information in the graphical user interface is determined. The play position includes: the video play window, and/or the target function control related to the target function in the graphical user interface. The first video information is played at the play position. In this method, the function of the game is recommended to the user in the play window or function control of the game interface in the form of video information. On the one hand, the video information can provide the operation information of the target function more efficiently. On the other hand, playing the video information in the play window or the function control is conducive for users to quickly discover the new function in the game, improves effect of recommendation of the new function, can continuously provide a sense of freshness to the game user, and reduces the game user churn rate.

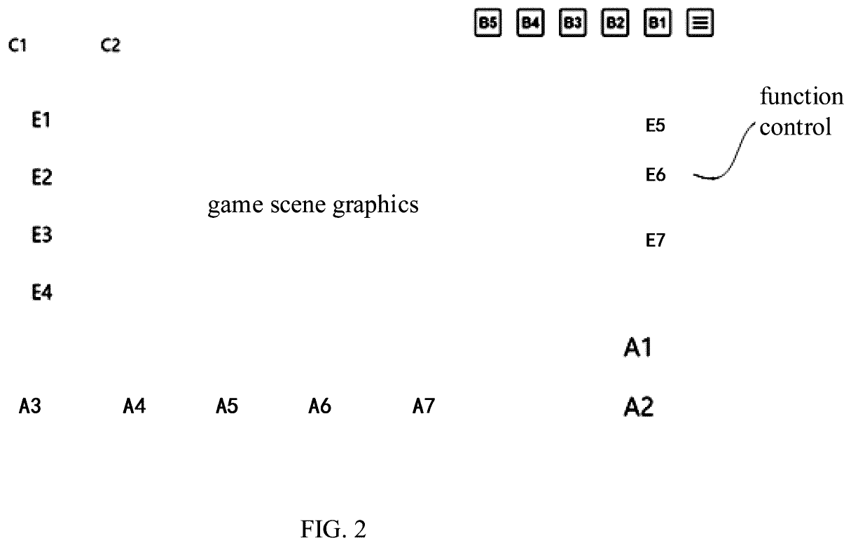

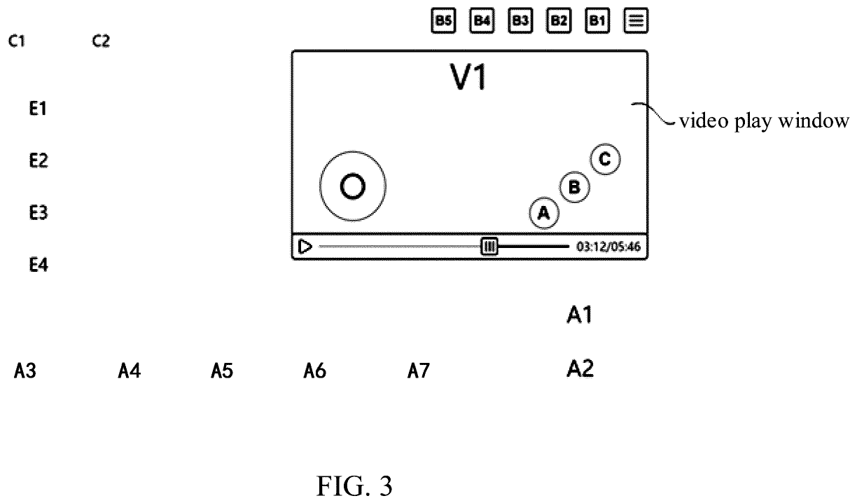

The following is a detailed description of the interactive mode of the information recommendation method of the embodiment based on different play positions. FIG. 2 shows a schematic diagram of a graphical user interface. The graphical user interface includes a game scene graphic and a variety of function controls. The function controls are usually located at relative edge positions of the graphical user interface. In this interface, no video information is played. If the play position includes a video play window, a video play window is generated in the graphical user interface, and the first video information is played in the video play window. As shown in FIG. 3, as an example, a video play window is displayed in the upper right corner of the graphical user interface, and the first video information is played in the video play window. It should be noted that the video play window may shield a part of the game scene graphics or function controls, and therefore an adjustment interface for the size, shape, display position, video play rate, etc. of the video play window may be provided, and a closing interface for the video play window may also be provided to enable a user to adjust the video play window based on his/her own needs.

When the first video information is played in the video play window, in response to a designate operation, a function operation page of the target function is displayed in the graphical user interface, or an operation instruction animation of the target function is played in the graphical user interface. The operation instruction animation includes: operation information for triggering display of the function operation page of the target function in the graphic user interface.

The above-mentioned designated operation includes: a trigger operation acting on the video play window, or a trigger operation acting on a designated control in the video play window. The trigger operation acting on the video play window may be a click/tap operation, a double-click/double-tap operation, or a long press operation on a window edge of the video play window; or, a designated control may be set in the video play window, and the user may implement the above-mentioned designated operation by clicking/tapping the designated control. The purpose of the designated operation is to provide the user with a function operation page or an operation instruction animation of the target function.

In a method, after the user performs the above-mentioned designate operation, the function operation page of the target function is displayed in the graphical user interface. That is, after the user performs the designate operation, the target function may be triggered, and the function operation page of the target function may be used by the user to implement the operation procedure of the target function. Specifically, the graphical user interface jumps from the above-mentioned game scene graphic to the function operation page of the target function. For example, if the target function is Player VS Player (PVP, a battle between players) gameplay, then the function operation page of the target function is a page for implementing the PVP gameplay.

In another method, after the user performs the above-mentioned designate operation, the operation instruction animation of the target function is played. The operation instruction animation may be in the form of arrow(s), circle(s), text, etc. to indicate which function control to enter to trigger the target function.

In addition to the above methods, the target function control may be displayed in a first display mode in the graphical user interface during the playing of the first video information in the video play window or after the first video information is played. The first display mode is used to indicate that the first video information is associated with the target function control. For example, the first display mode may be a highlight display mode, a flashing display mode, or an enlarged display mode, etc. Through the first display mode, the user may clearly know the target function recommended in the first video information and through which function control to enter, thereby further attracting traffic for the target function.

In the above method, a variety of operation methods are provided for users to experience the target function after watching the first video information, attract traffic for the target function, and provide game users with new game experience and operations.

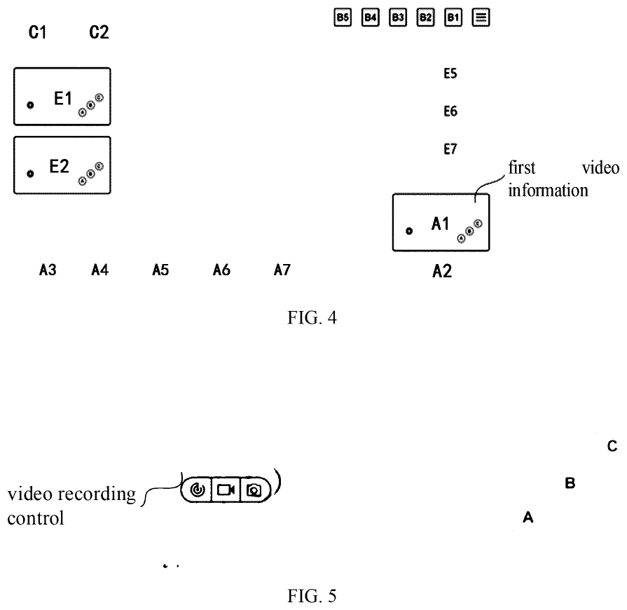

In another implementation, if the play position includes the target function control related to the target function, the control size of the target function control is adjusted, and the first video information is played on the adjusted target function control. As shown in FIG. 4, as an example, first video information related to the function control E1 is being played on the function control E1, first video information related to the function control E2 is being played on the function control E2, and first video information related to the function control A1 is being played on the function control A1. Considering that the control size of a function control is usually small, before playing the first video information on the target function control, the control size of the target function control may be adjusted. For example, the target function control may be enlarged. In other methods, the control shape of the target function control may also be adjusted. For example, the control shape is adjusted to match the shape of a video frame in the first video information, so as to facilitate the playing of the first video information.

In order not to affect the normal operation of a user on the graphical user interface, other interactive functions for the target function control may also be provided. For example, through a long press operation or other operations, the play of the first video information on the target function control may be canceled. Alternatively, a temporary control may be displayed near the target function control, and the playing of the first video information on the target function control may be canceled by triggering the temporary control.

When the first video information is played in the target function control, in response to the trigger operation acting on the target function control, the function operation page of the target function is displayed in the graphical user interface. The trigger operation acting on the target function control may specifically be a click/tap operation, a double-click/double-tap operation, or a long press operation acting on the target function control. After the target function control is triggered, the function operation page of the target function is displayed in the graphical user interface, and the target function may be triggered. The function operation page of the target function may be used by the user to implement the operation procedure of the target function. Specifically, the graphical user interface jumps from the above-mentioned game scene graphic to the function operation page of the target function.

In the above methods, by playing video information of related function(s) through a function control, the efficiency of function recommendation can be improved, and users can also intuitively understand the triggering method of the recommended function, thereby increasing the usage of the function.

When playing the first video information at the play position, there are multiple play modes. Specifically, the function type information of the target function is acquired from the information recommendation instruction. The first play mode of the first video information is determined based on the function type information, and the first video information is played at the play position according to the first play mode. The first play mode includes: playing the first video information in a loop, or live streaming the first video information and video information subsequent to the first video information.

In a method, if a user does not perform a trigger operation on the video play window or the target function, the first video information is played in a loop at the play position, or multiple pieces of video information are sequentially played in a loop at the same play position. In another method, a user who uploads the first video information also records video information subsequent to the first video information, or the user is live streaming a game, and after playing the first video information in the above play mode, the video information subsequent to the first video information continues to be played, or the user's current live video information may continue to be played.

In an actual implementation, the first play mode of the first video information may be determined according to the function type information of the target function. For example, when the target function is PVP gameplay, a user's PVP peak moment may be live streamed. For another example, when the target function is equipment crafting, the moment when multiple players obtain gold equipment may be presented in a loop.

In this method, a variety of play modes are set, and different play modes are set according to the function type, so as to improve the efficiency of function recommendation.

In order to make the play of video information more satisfy the needs of users, when the first video information is played at the play position, in response to a first operation acting on the first video information, the first video information is played in a second play mode indicated by the first operation. The first operation includes one or more of: a volume adjustment operation, a video switching operation, a video scaling operation, a preview operation and a play speed adjustment operation. In a specific mode, the first video information being played may be swiped up and down to adjust the play volume, and the first video information may be swiped left and right to switch the video information; the first video information may be scaled by performing a two-finger zoom operation on the first video information, and the first video information may be long-pressed to achieve magnified preview or fast-forward of the first video information. The play effects corresponding to different first operation modes can be set according to actual needs.

In this method, users are provided with a variety of interactive operations on the video, which can meet various video play needs and thus improve the efficiency of function recommendation.

In the embodiment, a user can not only watch the recommended first video information, but also record the video information by himself/herself through an interactive operation and recommend it to other users for viewing. In a specific manner, in response to a designated trigger event, a screen recording operation is performed on the graphical user interface to obtain second video information. The designated trigger event includes that a preset event is triggered, or a preset control is triggered. Based on the presented content in the graphical user interface during the screen recording operation, or a user setting instruction for the second video information, the function type information of the second video information is determined.

FIG. 5 is taken as an example, a screen recording control, i.e., the above-mentioned preset control, may be set in the graphical user interface. When the screen recording control is clicked/tapped, a screen recording operation of the graphical user interface starts. When the screen recording control is clicked/tapped again, the screen recording operation ends and the above-mentioned second video information is acquired, or when the current function operation is completed, the screen recording operation ends automatically to acquire the above-mentioned second video information.

FIG. 6 is another example. A user may pre-set the above-mentioned preset event. For example, the preset event is that function A is triggered. When function A is triggered by the user, a screen recording operation starts automatically. In FIG. 6, an automatic screen recording prompt identifier is displayed in the graphical user interface to prompt the user that the screen is currently being recorded. When the operation of the function A is completed, the screen recording operation ends to acquire the above-mentioned second video information.

In actual implementation, after the screen recording operation is completed, the initial video of the second video information may be obtained. The initial video may be automatically or manually clipped and compressed to obtain a short video within a designated time length, that is, the final second video information. The function type information of the second video information may be acquired during screen recording or may be set by the user. The function type information is divided depending on functions, for example, the function type information may be divided into functions such as a backpack, a mall, an instance zone, a friend, a chat, an activity and equipment, etc. The function type information may alternatively divided according to gameplay, for example, the function type information may be divided into instance zone brushing, PVP, Player Versus Environment (PVE), farming equipment, gacha, tower climbing, socializing or walking, etc. It is also possible to set a keyword for the second video information in the function type information based on the content of the second video information. The keyword may reflect the core content of the second video information, such as obtaining gold equipment, fighting super gods, cumulative logins or crazy top up money, etc.

The user may also set a push range of the second video information. For example, the second video information is only pushed to users who log into a designated regional server. After the user uploads the second video information, the game server may determine users to which the second video information is to be pushed based on account attribute information such as the push range set by the user, users' level, rank, ranking, popularity, authentication and so on, as well as the core gameplay information of the game, and push the second video information to terminal devices of these users.

In the above method, by performing recording to obtain video information when the user implements the function operation and pushing the video information to other users, the diversity and interest of the video information can be improved, the probability of the user triggering a new function can be increased, and the efficiency of the new function recommendation can be improved.

The information recommendation method in the embodiments provides a faster, flatter and more random function presentation approach, which is more in line with the fragmented game experience, can continuously provide players with experience goals, keep the game freshness, and slow down the loss rate of players.

The above information recommendation method combines more functions for controls without increasing the number of controls, thereby improving the operating efficiency of a single control. Based on traditional information prompts such as text and pictures, a dynamic video function presentation method is added to controls. Complex operations can be intuitively reproduced through dynamic videos, reducing the learning cost. A part of entry controls having functions that can be combined are reduced, thereby improving the utilization rate of screen space. A single control can realize the functions of multiple entries, shortening and eliminating a physical distance in the scene, and making the operation smoother. The rich functions do not require manual maintenance, and the fixed presentation ensures the probability of effective delivery of the video information. Based on the actual click/tap situation of the content, the button intelligently pushes the content that players like, which can improve the experience viscosity; there is no upper limit to function mapping, and the content presentation changes intelligently according to the interaction manner.

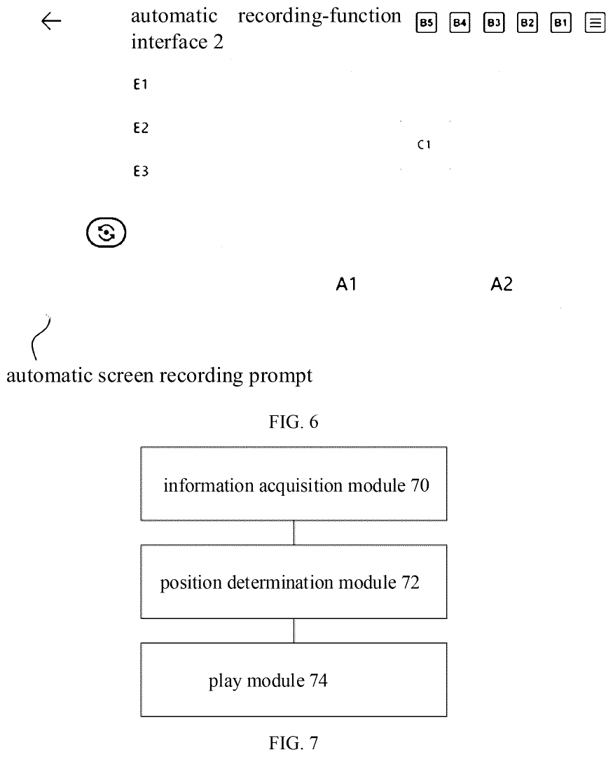

Corresponding to the above method embodiments, FIG. 7 is a schematic diagram of the structure of an information recommendation apparatus. A graphical user interface is provided through a terminal device. The graphical user interface includes a game scene graphic and a function control. The apparatus includes an information acquisition module 70, a position determination module 72 and a play module 74.

The information acquisition module 70 is configured to, in response to receiving information recommendation instruction, acquire first video information from the information recommendation instruction. The first video information includes operation instruction information for realizing a target function.

The position determination module 72 is configured to determine a play position of the first video information in the graphical user interface. The play position includes: a video play window, and/or a target function control related to the target function in the graphical user interface.

The play module 74 is configured to play the first video information at the play position.

In the above-mentioned information recommendation apparatus, in response to receiving the information recommendation instruction, the first video information is acquired from the information recommendation instruction. The first video information includes operation instruction information for realizing the target function. The play position of the first video information in the graphical user interface is determined. The play position includes the video play window, and/or, the target function control related to the target function in the graphical user interface. The first video information is played at the play position. In this manner, the function of a game is recommended to a user in the play window or the function control of the game interface in the form of video information. On the one hand, the video information can provide the operation information of the target function more efficiently. On the other hand, playing the video information in the play window or the function control is conducive for users to quickly discover the target function, improves the effect of recommendation of the new function, can continuously provide a sense of freshness to game users, and reduces the game user churn rate.

The play module is further configured to: if the play position includes the video play window, generate the video play window in the graphical user interface, and play the first video information in the video play window.

The apparatus further includes: a first page display module configured to display a function operation page of the target function in the graphical user interface in response to a designate operation, or to play an operation instruction animation of the target function in the graphical user interface. The operation instruction animation includes operation information for triggering the display of the function operation page of the target function in the graphical user interface. The designate operation includes a trigger operation acting on the video play window, or a trigger operation acting on a designated control in the video play window.

The apparatus further includes: a control display module configured to display the target function control in a first display mode in the graphical user interface. The first display mode is used to indicate that the first video information is associated with the target function control.

The play module is further configured to: if the play position includes the target function control related to the target function, adjust the control size of the target function control, and play the first video information on the adjusted target function control.

The apparatus further includes: a second page display module configured to, in response to a trigger operation acting on the target function control, display the function operation page of the target function in the graphical user interface.

The play module is further configured to: obtain function type information of the target function from the information recommendation instruction; determine a first play mode of the first video information based on the function type information, and play the first video information at the play position according to the first play mode. The first play mode includes: playing the first video information in a loop, or live streaming the first video information and video information subsequent to the first video information.

The apparatus further includes: a video adjustment module configured to, in response to a first operation acting on the first video information, play the first video information in a second play mode indicated by the first operation. The first operation includes one or more of: a volume adjustment operation, a video switching operation, a video scaling operation, a preview operation and a play speed adjustment operation.

The position determination module is further configured to: obtain function type information of the target function from the information recommendation instruction; and determine the target function control that matches the function type information from the graphical user interface.

The apparatus further includes a video recording module configured to perform a screen recording operation of the graphical user interface in response to a designated trigger event to obtain second video information, where the designated trigger event includes that a preset event is triggered, or a preset control is triggered; based on the content presented in the graphical user interface during the screen recording operation, or a user setting instruction for the second video information, determine function type information of the second video information.

Using the information recommendation method and apparatus and the electronic device provided in the embodiments, a traditional button that displays static information and has a single mapping relationship is optimized into a video button that presents dynamic information and has a multi-correlation mapping relationship, thereby improving the efficiency of information presentation and increasing the efficiency of control operation. There is no upper limit to the mapping of function entries, and the content presentation changes intelligently according to the interaction method. The experience procedure of the game can meet the requirements of fragmentation and randomization. More functions are compounded without increasing the number of controls, which improves the operating efficiency of the overall main interface. Innovatively, on the basis of traditional information prompts such as text and pictures, a function display method of dynamic content is added. The spread efficiency of dynamic videos is high, which reduces the amount of time for players to learn and get started. The embodiments of the present disclosure can continue to provide players with experience goals, maintain freshness, and slow down the loss rate of players. Future content adjustments or enrichments do not require manual maintenance. According to the actual click/tap situation of the content, the button intelligently pushes the content that players like, ensuring effective delivery of video information and improving the viscosity of the experience.

An embodiment further provides an electronic device, including a processor and a memory. The memory stores machine-executable instructions that can be executed by the processor. The processor executes the machine-executable instructions to implement the above information recommendation methods. The electronic device may be a server or a terminal device.

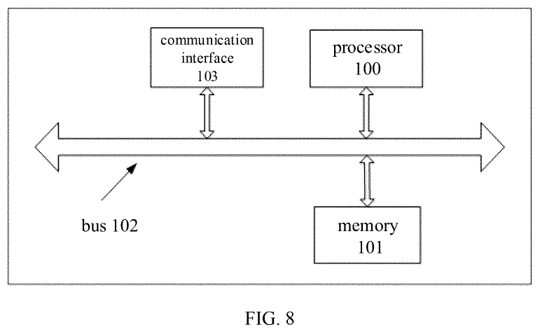

As shown in FIG. 8, an electronic device includes a processor 100 and a memory 101. The memory 101 stores machine-executable instructions that can be executed by the processor 100. The processor 100 executes the machine-executable instructions to implement the above information recommendation methods, including for example:

in response to receiving an information recommendation instruction, acquiring first video information from the information recommendation instruction, where the first video information includes operation instruction information for implementing a target function; determining a play position of the first video information in a graphical user interface, where the play position includes a video play window, and/or a target function control related to the target function in the graphical user interface; and playing the first video information at the play position.

The step of playing the first video information at the play position includes: if the play position includes the video play window, generating the video play window in the graphical user interface, and playing the first video information in the video play window.

After the step of playing the first video information in the video play window, the method further includes: in response to a designate operation, displaying a function operation page of the target function in the graphical user interface, or, playing an operation instruction animation of the target function in the graphical user interface, where the operation instruction animation includes operation information for triggering display of a function operation page of the target function in the graphical user interface; where the designate operation includes: a trigger operation acting on the video play window, or a trigger operation acting on a designated control in the video play window.

The above embodiment allows users to experience the target function after watching the first video information, realizes attracting traffic for the target function, and provides new game experience and operations for game users.

After the step of playing the first video information in the video play window, the method further includes: displaying the target function control in a first display mode in the graphical user interface, where the first display mode is used to indicate that the first video information is associated with the target function control.

The above embodiment can enable users to clearly know the target function recommended in the first video information and through which function control to enter, thereby further attracting traffic for the target function.

The step of playing the first video information at the play position includes: if the play position includes the target function control related to the target function, adjusting the control size of the target function control, and playing the first video information on the adjusted target function control.

After the step of playing the first video information on the adjusted target function control, the method further includes: in response to a trigger operation acting on the target function control, displaying a function operation page of the target function in the graphical user interface.

Playing the video information of a related function through the function control can improve the efficiency of function recommendation, and users can also intuitively understand the triggering method of the recommended function, thereby increasing the usage of the function.

The step of playing the first video information at the play position includes: acquiring function type information of the target function from the information recommendation instruction; determining a first play mode of the first video information based on the function type information, and playing the first video information at the play position according to the first play mode, where the first play mode includes: playing the first video information in a loop, or live streaming the first video information and video information subsequent to the first video information.

Different play modes are set according to the types of functions, thereby improving the efficiency of function recommendation.

After the step of playing the first video information at the play position, the method further includes: in response to a first operation acting on the first video information, playing the first video information in a second play mode indicated by the first operation; where the first operation includes one or more of: a volume adjustment operation, a video switching operation, a video scaling operation, a preview operation, and a play speed adjustment operation.

The above embodiments provide users with a variety of interactive operations on videos, which can meet various video play needs, thereby improving the efficiency of function recommendations.

The step of determining the play position of the first video information in the graphical user interface includes: obtaining function type information of the target function from the information recommendation instruction; and determining a target function control that matches the function type information in the graphical user interface.

The method further includes: in response to a designated trigger event, performing a screen recording operation on the graphical user interface to obtain second video information, where the designated trigger event includes that a preset event is triggered, or a preset control is triggered; based on a content presented in the graphical user interface during the screen recording operation, or a user setting instruction for the second video information, determining function type information of the second video information.

Function(s) of a game is (are) recommended to users in the form of video information on the play window or function control(s) of the game interface. On the one hand, video information can provide operation information of the target function more efficiently. On the other hand, playing video information on the play window or the function control(s) is conducive for users to quickly discover the target function, thereby improving the effect of recommendation of new function(s), continuously providing a sense of freshness to game users, and reducing the game user churn rate.

Furthermore, the electronic device shown in FIG. 8 further includes a bus 102 and a communication interface 103, and the processor 100, the communication interface 103 and the memory 101 are connected via the bus 102.

The memory 101 may include a high-speed Random Access Memory (RAM), and may also include a non-volatile memory, such as at least one disk storage. The communication connection between the system network element and at least one other network element is realized through at least one communication interface 103 (which may be wired or wireless), and the Internet, a wide area network, a local area network, or a metropolitan area network, etc. may be used. The bus 102 may be an Industry Standard Architecture (ISA) bus, a Peripheral Component Interconnect (PCI) bus or an EISA bus, etc. The bus may be divided into an address bus, a data bus, a control bus, etc. For ease of representation, only one bidirectional arrow is used in FIG. 8 to represent the bus(es), but it does not mean that there is only one bus or one type of bus.

The processor 100 may be an integrated circuit chip with a signal processing capability. In an implementation, each step of the above methods may be completed by a hardware integrated logic circuit or instructions in the form of software in the processor 100. The processor 100 may be a general-purpose processor, including a Central Processing Unit (CPU), a Network Processor (NP), etc. Alternatively, the processor 100 may be a Digital Signal Processor (DSP), an Application Specific Integrated Circuit (ASIC), a Field-Programmable Gate Array (FPGA) or other programmable logic device, a discrete gate or a transistor logic device, a discrete hardware component. The disclosed methods, steps and logic block diagrams in the embodiments of the present disclosure may be implemented or carried out. The general-purpose processor may be a microprocessor or the processor may also be any conventional processor, etc. The steps of the methods disclosed in conjunction with the embodiments of the present disclosure may be directly embodied as being carried out and completed by a hardware decoding processor, or being carried out and completed by a combination of hardware and software modules in the decoding processor. The software module may be located in a storage medium mature in the art, such as a random access memory, a flash memory, a read-only memory, a programmable read-only memory, or an electrically erasable programmable memory, a register, etc. The storage medium is located in the memory 101, and the processor 100 reads information in the memory 101 and completes the steps of the methods in the above embodiments in combination with its hardware.

An embodiment further provides a machine-readable storage medium, which stores machine-executable instructions. When the machine-executable instructions are called and executed by a processor, the machine-executable instructions cause the processor to implement the above-mentioned information recommendation method, including for example:

in response to receiving an information recommendation instruction, acquiring first video information from the information recommendation instruction, where the first video information includes operation instruction information for realizing a target function; determining a play position of the first video information in a graphical user interface, where the play position includes a video play window, and/or a target function control related to the target function in the graphical user interface; and playing the first video information is at the play position.

The step of playing the first video information at the play position includes: if the play position includes the video play window, generating the video play window in the graphical user interface, and playing the first video information in the video play window.

After the step of playing the first video information in the video play window, the method further includes: in response to a designate operation, displaying a function operation page of the target function in the graphical user interface, or, playing an operation instruction animation of the target function in the graphical user interface, where the operation instruction animation includes operation information for triggering displaying of the function operation page of the target function in the graphical user interface; where the designate operation includes: a trigger operation acting on the video play window, or a trigger operation acting on a designated control in the video play window.

The above embodiment allows users to experience the target function after watching the first video information, realizes attracting traffic for the target function, and provides new game experience and operations for game users.

After the step of playing the first video information in the video play window, the method further includes: displaying the target function control in a first display mode in the graphical user interface; where the first display mode is used to indicate that the first video information is associated with the target function control.

The above embodiment can enable users to clearly know the target function recommended in the first video information and through which function control to enter, thereby further attracting traffic for the target function.

The step of playing the first video information at the play position includes: if the play position includes the target function control related to the target function, adjusting the control size of the target function control, and playing the first video information on the adjusted target function control.

After the step of playing the first video information on the adjusted target function control, the method further includes: in response to a trigger operation acting on the target function control, displaying a function operation page of the target function in the graphical user interface.

Playing the video information of a related function through the function control can improve the efficiency of function recommendation, and users can also intuitively understand the triggering method of the recommended function, thereby increasing the usage of the function.

The step of playing the first video information at the play position includes: obtaining function type information of the target function from the information recommendation instruction; determining a first play mode of the first video information based on the function type information, and playing the first video information at the play position according to the first play mode; where the first play mode includes: playing the first video information in a loop, or live streaming the first video information and video information subsequent to the first video information.

Different play modes are set according to the types of functions, thereby improving the efficiency of function recommendation.

After the step of playing the first video information at the play position, the method further includes: in response to a first operation applied to the first video information, playing the first video information in a second play mode indicated by the first operation; where the first operation includes one or more of: a volume adjustment operation, a video switching operation, a video scaling operation, a preview operation, and a playback speed adjustment operation.

The above embodiment provides users with a variety of interactive operations on videos, which can meet various video playback needs, thereby improving the efficiency of function recommendation.

The step of determining the play position of the first video information in the graphical user interface includes: obtaining function type information of the target function from the information recommendation instruction; and determining a target function control that matches the function type information in the graphical user interface.

The above method further includes: in response to a designated trigger event, performing a screen recording operation on the graphical user interface to obtain second video information; where the designated trigger event includes that a preset event is triggered, or a preset control is triggered; based on a content presented in the graphical user interface during the screen recording operation, or a user setting instructions for the second video information, determining the function type information of the second video information.

Function(s) of a game is (are) recommended to users in the form of video information on the play window or a function control of the game interface. On the one hand, video information can provide operation information of the target function more efficiently. On the other hand, playing video information on the play window or the function control is helpful for users to quickly discover the target function, thereby improving the effect of recommendation of new function(s), continuously providing a sense of freshness to game users, and reducing the game user churn rate.

An embodiment of the present disclosure provides a computer-readable storage medium storing a program code. The instructions included in the program code may be used to implement the methods described in the previous method embodiments. The specific implementations can be found in the method embodiments, which will not be repeated here.

Those skilled in the art can clearly understand that, for the convenience and brevity of description, for the specific working procedure of the system and apparatus described above, reference may be made the corresponding processes in the aforementioned method embodiments, and will not be repeated here.

In addition, in the description of the embodiments of the present disclosure, unless otherwise clearly specified and limited, the terms “installed/installment”, “connected”, and “connection” should be understood in a broad sense, for example, it may be a fixed connection, a detachable connection, or an integral connection; it may be a mechanical connection or an electrical connection; it may be a direct connection or it may be an indirect connection through an intermediate medium, or it may be an internal communication of two components. For those skilled in the art, the specific meanings of the above terms in the present disclosure may be understood according to specific circumstances.

If functions are implemented in the form of software function units and sold or used as an independent product, they may be stored in a computer-readable storage medium. Based on this understanding, the technical solutions of the present disclosure, or a part that contributes to related art or a part of the technical solutions, may be embodied in the form of a software product. The computer software product is stored in a storage medium, including several instructions to enable a computer device (which may be a personal computer, a server, or a network device, etc.) to perform all or part of the steps of the methods described in the embodiments of the present disclosure. The storage medium includes a medium that can store a program code, such as: a U disk, a mobile hard disk, a Read-Only Memory (ROM), a Random Access Memory (RAM), a magnetic disk or an optical disk, etc.

In the description of the present disclosure, it should be noted that orientations or positional relationships indicated by terms “center”, “upper”, “lower”, “left”, “right”, “vertical”, “horizontal”, “inner”, “outer”, etc. are based on orientations or positional relationships shown in the accompanying drawings, and are only for the convenience of describing the present disclosure and simplifying the description, rather than indicating or implying that the apparatus or elements referred to must have a specific orientation or must be constructed and operated in a specific orientation. Therefore, these terms cannot be understood as a limitation of the present disclosure. In addition, the terms “first”, “second”, and “third” are used for descriptive purposes only, and cannot be understood as indicating or implying relative importance.

Finally, it should be noted that the above embodiments are only example implementations of the present disclosure, which are used to illustrate the technical solutions of the present disclosure, rather than to limit the present disclosure. The protection scope of the present disclosure is not limited to the disclosed embodiments. Although the present disclosure is described in detail with reference to the above embodiments, those skilled in the art should understand that any technician familiar with the technical field can still modify the technical solutions recorded in the above embodiments within the technical scope disclosed in the present disclosure, or can easily think of changes, or make equivalent substitutions for a part of the technical features herein; and these modifications, changes or substitutions do not make the essence of the corresponding technical solutions deviate from the spirit and scope of the technical solutions of the embodiments of the present disclosure, and should fall within the protection scope of the present disclosure. Therefore, the protection scope of the present disclosure should be defined by the protection scope of the claims.

1. An information recommendation method, comprises:
in response to receiving an information recommendation instruction, acquiring first video information from the information recommendation instruction, wherein the first video information comprises operation instruction information for realizing a target function;
determining a play position of the first video information in a graphical user interface, wherein the play position comprises at least one of a video play window or a target function control related to the target function in the graphical user interface; and
playing the first video information at the play position.

2. The method according to claim 1, wherein playing the first video information at the play position comprises:
in response to the play position comprising the video play window, generating the video play window in the graphical user interface, and playing the first video information in the video play window.

3. The method according to claim 2, wherein the method further comprises:
in response to a designated operation, displaying a function operation page for the target function in the graphical user interface, or playing an operation instruction animation for the target function in the graphic user interface, wherein the operation instruction animation comprises operation information for triggering displaying of the function operation page for the target function in the graphic user interface;
wherein the designated operation comprises: a trigger operation acting on the video play window in which the first video information is played, or a trigger operation acting on a designated control in the video play window.

4. The method according to claim 2, wherein the method further comprises:
displaying the target function control in a first display mode in the graphical user interface in response to playing the first video information in the video play window, wherein the first display mode is configured to indicate that the first video information is associated with the target function control.

5. The method according to claim 1, wherein playing the first video information at the play position comprises:
in response to the play position comprising the target function control related to the target function, adjusting a control size of the target function control, and playing the first video information on the adjusted target function control.

6. The method according to claim 5, wherein the method further comprises:
in response to a trigger operation acting on the adjusted target function control on which the first video information is played, displaying a function operation page for the target function in the graphical user interface.

7. The method according to claim 1, wherein playing the first video information at the play position comprises:
acquiring function type information of the target function from the information recommendation instruction; and
determining a first play mode for the first video information based on the function type information, and playing the first video information at the play position according to the first play mode, wherein the first play mode comprises: playing the first video information in a loop, or live streaming the first video information and video information subsequent to the first video information.

8. The method according to claim 1, wherein the method further comprises:
in response to a first operation acting on the first video information which is played at the play position, playing the first video information in a second play mode indicated by the first operation, wherein the first operation comprises one or more of: a volume adjustment operation, a video switching operation, a video scaling operation, a preview operation, or a play speed adjustment operation.

9. The method according to claim 1, wherein determining the play position of the first video information in the graphical user interface comprises:
acquiring function type information of the target function from the information recommendation instruction; and
determining the target function control matching the function type information from the graphical user interface.

10. The method according to claim 1, further comprising:
in response to a designated trigger event, performing a screen recording operation on the graphical user interface to obtain second video information, wherein the designated trigger event comprises that a preset event is triggered, or a preset control is triggered; and
based on a content presented in the graphical user interface during the screen recording operation, or a user setting instruction for the second video information, determining function type information of the second video information.

11. (canceled)

12. An electronic device, comprising a processor and a memory, wherein the memory stores machine-executable instructions executable by the processor, and when the processor executes the machine-executable instructions the electronic device is caused to:
in response to receiving an information recommendation instruction, acquire first video information from the information recommendation instruction, wherein the first video information comprises operation instruction information for realizing a target function;
determine a play position of the first video information in a graphical user interface, wherein the play position comprises at least one of a video play window or a target function control related to the target function in the graphical user interface; and
play the first video information at the play position.

13. A non-transitory computer-readable storage medium having machine-executable instructions stored thereon, wherein when the machine-executable instructions are called and executed by a processor, the machine-executable instructions cause the processor to:
in response to receiving an information recommendation instruction, acquire first video information from the information recommendation instruction, wherein the first video information comprises operation instruction information for realizing a target function;
determine a play position of the first video information in a graphical user interface, wherein the play position comprises at least one of a video play window or a target function control related to the target function in the graphical user interface; and
play the first video information at the play position.

14. The method according to claim 1, further comprising:
displaying a temporary control near the target function control, wherein when the temporary is triggered, playing of the first video information on the target function control is cancelled.

15. The method according to claim 1, wherein the information recommendation method is performed by a cloud game server in a cloud interaction system, and playing the first video information at the play position comprises:
sending the first video information to a client device in the cloud interaction system to play the first video information via a display of the client device.

16. The method according to claim 1, wherein the information recommendation method is performed by a terminal device, and playing the first video information at the play position comprises:
playing the first video information via a display of the terminal device.

17. The method according to claim 10, further comprising:
based on a push range of the second video information, pushing the second video information to a terminal device of a user within the push range.

18. The electronic device according to claim 12, wherein when the processor executes the machine-executable instructions, the electronic device is caused to:
in response to the play position comprising the video play window, generate the video play window in the graphical user interface, and playing the first video information in the video play window.

19. The electronic device according to claim 18, wherein when the processor executes the machine-executable instructions, the electronic device is further caused to:
in response to a designated operation, display a function operation page for the target function in the graphical user interface, or playing an operation instruction animation for the target function in the graphic user interface, wherein the operation instruction animation comprises operation information for triggering displaying of the function operation page for the target function in the graphic user interface;
wherein the designated operation comprises: a trigger operation acting on the video play window in which the first video information is played, or a trigger operation acting on a designated control in the video play window.

20. The electronic device according to claim 18, wherein when the processor executes the machine-executable instructions, the electronic device is caused to:
display the target function control in a first display mode in the graphical user interface in response to playing the first video information in the video play window, wherein the first display mode is used to indicate that the first video information is associated with the target function control.

21. The electronic device according to claim 12, wherein when the processor executes the machine-executable instructions, the electronic device is caused to:
in response to the play position comprising the target function control related to the target function, adjust a control size of the target function control, and playing the first video information on the adjusted target function control.
